(19) United States
(12) Patent Application Publication
(10) Pub. No.: US 2026/0024315 A1
(43) Pub. Date: Jan. 22, 2026

(54) METHODS FOR EDGE CASE DETECTION AND FURTHER OPTIMIZATION OF OBJECT DETECTION MODELS

(71) Applicant: Robert Bosch GmbH, Stuttgart (DE)

(72) Inventors: Xiaoyu ZHANG, Davis, CA (US); Jorge Henrique PIAZENTIN ONO, Sunnyvale, CA (US); Wenbin HE, Sunnyvale, CA (US); Liang GOU, San Jose, CA (US); Liu REN, Saratoga, CA (US)

(21) Appl. No.: 18/779,741

(22) Filed: Jul. 22, 2024

(51) Int. Cl. G06V 10/774; G06F 40/40; G06N 3/0475; G06N 3/088; G06V 10/74; G06V 10/764; G06V 10/776; G06V 10/82; G06V 10/94

(52) U.S. Cl. CPC G06V 10/774; G06F 40/40; G06N 3/0475; G06N 3/088; G06V 10/761; G06V 10/764; G06V 10/776; G06V 10/82; G06V 10/945

(57) ABSTRACT

Methods for a machine learning network that provide efficient, scalable, and granular analyses during validation of an object detection model are disclosed. The system described herein is configured to use extraction of visual concepts to provide interpretable metadata to a data slice finding technique. The identified, poor-performing slices are then provided to a user for selection as to which slice or slices to focus on when preparing a subsequent training dataset that is to be used to further refine the object detection model. The system then coordinates with a large language model and with a vision and language foundational model to augment the original validation dataset with supplementary image samples that are determined to be associated with the problems currently causing poor performance of the model.

### TECHNICAL FIELD

The present disclosure relates to techniques for validation and edge case detection of a machine learning model.

### BACKGROUND

In recent years, the advancement of machine learning techniques has significantly expanded the scope of problems that can be addressed through computational solutions. Notably, machine learning has found applications in various critical tasks, including but not limited to intelligent transportation, medical image processing, and e-commerce. Given the stringent demands for effectiveness and reliability in these scenarios, it becomes imperative to ensure the validity of such machine learning models, particularly in terms of their robustness in critical edge cases. However, determining how to parse through such large datasets and detect relevant error patterns to correct for remains a challenge for the scientific community.

### SUMMARY

As machine learning gains wider adoption in real-world applications, the validation of ML models becomes fundamental for its commercialization, and particularly in safety-critical applications, such as autonomous driving. Recently, data slice finding has emerged as a method for validating machine learning models. However, previous implementations of data slice finding techniques have required additional metadata or cross-modal embeddings in order for the data slices to be interpretable. In the invention disclosure herein, a machine learning network is configured to coordinate the slicing of computer vision models using visual concepts. This approach allows for the image dataset to be broken down into interpretable visual concepts, thus performing as metadata in the slice finding process. By providing methods for utilizing data slice finding techniques through the use of visual concepts, the machine learning network described herein provides insights into directed model issues during a validation process, and enables a deeper understanding of the strengths and weaknesses of computer vision models during an overall process of training.

### BRIEF DESCRIPTION OF THE DRAWINGS

FIG. 1 illustrates a system for training a neural network, according to some embodiments.

FIG. 2 illustrates a computer-implemented method for training and utilizing a neural network, according to some embodiments.

FIG. 3A is a workflow diagram that illustrates a process of executing an object detection model using a validation dataset and subsequently determining one or more methods for further fine-tuning the model, according to some embodiments.

FIG. 3B is an algorithm that illustrates a component of the process introduced in FIG. 3A, wherein natural language descriptions are organized based on similarity to one another, according to some embodiments.

FIG. 3C is another workflow diagram that further illustrates the process introduced in FIG. 3A, wherein encodings of natural language descriptions and of supplementary images are used to generate images that may be used within a supplementary training dataset, according to some embodiments.

FIGS. 4A and 4B illustrate an example application of the workflow diagram, introduced in FIG. 3A, into an edge case detection iteration for a given object detection model, according to some embodiments.

FIGS. 5A and 5B illustrate another example application of the workflow diagram, introduced in FIG. 3A, into an edge case detection iteration for another object detection model, according to some embodiments.

FIG. 6 is a flow diagram that illustrates a process of identifying slices, subsequent to executing a validation dataset through an object detection model, and then using that analytical information to prepare an additional training dataset to further train the object detection model, according to some embodiments.

FIG. 7 is another flow diagram that further illustrates the process introduced in FIG. 6, wherein FIG. 7 demonstrates moments of interaction between a user of a machine learning network and the processors that are executing the object detection model, according to some embodiments.

FIG. 8 depicts a schematic diagram of an interaction between a computer-controlled machine and a control system, according to some embodiments.

FIG. 9 depicts a schematic diagram of the control system of FIG. 8 configured to control a vehicle, which may be a partially autonomous vehicle, a fully autonomous vehicle, a partially autonomous robot, or a fully autonomous robot, according to some embodiments.

FIG. 10 depicts a schematic diagram of the control system of FIG. 8 configured to control a manufacturing machine, such as a punch cutter, a cutter, or a gun drill, of a manufacturing system, such as part of a production line, according to some embodiments.

FIG. 11 depicts a schematic diagram of the control system of FIG. 8 configured to control a power tool, such as a power drill or driver, that has an at least partially autonomous mode, according to some embodiments.

FIG. 12 depicts a schematic diagram of the control system of FIG. 8 configured to control an automated personal assistant, according to some embodiments.

FIG. 13 depicts a schematic diagram of the control system of FIG. 8 configured to control a monitoring system, such as a control access system or a surveillance system, according to some embodiments.

FIG. 14 depicts a schematic diagram of the control system of FIG. 8 configured to control an imaging system, for example an MRI apparatus, x-ray imaging apparatus, or ultrasonic apparatus, according to some embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Data slice finding acts as an efficient method for validating machine learning models by uncovering potential issues on data subsets. However, achieving transparency and interpretability in data slice finding has, in the past, often necessitated the incorporation of additional metadata or cross-modal embeddings to interpret the outcomes and to align them with domain experts' knowledge. Previous implementations of data slice finding also required that machine learning domain practitioners have additional support to comprehend and deduce why the model fails on these slices before deciding which slice to prioritize for model optimization. Moreover, those previous implementation of gathering the appropriate data to mitigate a model issue was a resource-intensive process, both in terms of cost and time. This highlights the need for more efficient methodologies in data collection and model optimization, such as by use of the systems and methods described herein.

In order to address these challenges, the present disclosure is designed to assist machine learning researchers and engineers that are involved in computer vision tasks, and specifically focusing on diagnosing object detection models and developing more effective data augmentation strategies. Unlike previous implementations of data slice finding, the present disclosure does not require additional metadata or cross-modal embeddings as inputs to data slice finding algorithms. The machine learning network described herein instead leverages the semantic information inherent in the images themselves, and generates visual concepts using a self-supervised semantic segmentation model. Using these extracted visual concepts as metadata, the machine learning network herein can perform and present the slice finding results to users through a variety of visualizations and interactions, implemented using a user interface.

In addition, the present disclosure coordinates the retrieval of additional image samples that are then used to augment the image samples from the validation dataset in order to generate a supplemental training dataset to fine-tune the object detection model. By coordinating between a large language model, a vision and language foundational model, and the user themselves, the machine learning network described herein is configured to efficiently provide a more substantive and directed edge case detection scheme, along with also providing supplemental training datasets in response to the analytical information that is gained from the data slice finding techniques described herein. The present disclosure thus equips researchers and practitioners with a more profound understanding of the strengths and weaknesses of the computer vision models.

The following paragraphs detail measurable and quantifiable improvements that the present disclosure provides to machine learning users and experts.

Firstly, the data slice finding algorithm described herein is configured to detect data slices wherein the object detection model's performance dips below an average, thus offering a comprehensive overview of the current state of the model's performance. The data slice finding process is also modified to be breadth-first, such that the identified data slices are easily interpretable by humans. In addition, and as introduced above, the data slice finding algorithm is configured to provide such improvements using information that is inherent to the image samples themselves, without the necessity for additional metadata.

Secondly, the systems and methods described herein are configured to implement a user interface that provides identified data slices to the user, and directs them with how to diagnose reasons behind current model failure(s) on particular data slices. Using the user interface, users are able to analyze image samples within each slice, and view the inference results produced by the model.

Thirdly, the systems and methods described herein are configured to provide proposed solutions to the identified problems during the edge case detection phase, in order to facilitate completion of a machine learning optimization loop. As the types of machine learning models described herein fall largely under object detection based models, human-in-the-loop style interactions between the machine learning network and the user better facilitate the understanding of the current weaknesses of the model and subsequent fine-tuning that should be used to mitigate. Often, ML experts may provide domain knowledge and insights into crucial data slices that provide for more directed and optimal training datasets that are generated with specific purposes of reducing spurious correlations, positive/negative patterns within the current state of the model, etc. The machine learning network is thus configured to convert the domain knowledge of the user into actionable insights throughout the process of edge case detection and model optimization. Moreover, in order for user to be able to optimize the model using dataset augmentation, such as that which is described herein, additional image samples that are used to augment existing training datasets must possess visual concepts and/or object classes that are similar to the critical data slices and to natural language descriptions that are verified by the user. Human-in-the-loop interactions thus allow for the supplemental training datasets to be augmented based on user specifications.

The present disclosure continues with detailing the types of machine learning models that the methods and systems described herein may be used to validate, followed by description pertaining to data slice finding techniques that are used to provide improved methods for edge case detection and subsequent model optimizations. The present disclosure then demonstrates the versatility of the methods and systems described herein for use in validation and edge case detection of object detection models.

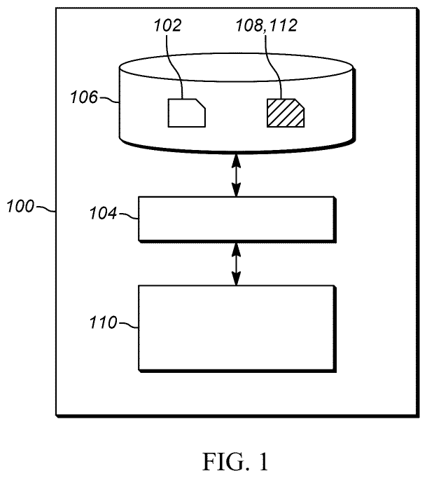

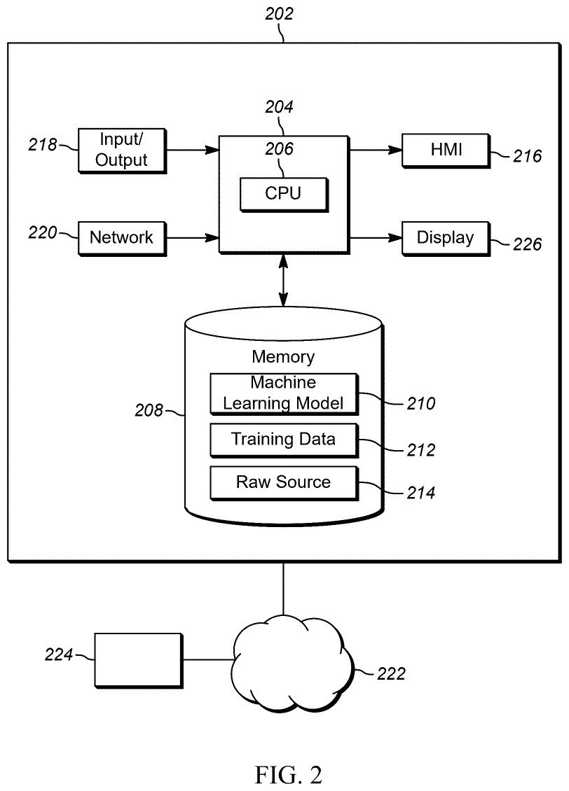

FIG. 1 illustrates a system 100 for training a neural network, such as a deep neural network. It should be understood that, while the example embodiments given in the following paragraphs herein with regard to FIGS. 1 and 2 refer to a deep neural network, additional embodiments of FIGS. 1 and 2 may be applied to any other type of neural-network-based or non-neural-network-based machine learning model that is configured to be developed, trained, and optimized for various computer vision applications that are related to object detection, image classification, image segmentation, etc.

Moreover, and as related to the description herein, a “deep” learning model, such as a deep neural network, may be defined as having multiple hidden layers (e.g., tens or hundreds of hidden layers) in between an input layer and an output layer of the model. A deep learning model may additionally be used to describe a machine learning model that is configured to learn complex patterns and representations based on training and/or validation datasets that are used as inputs to the deep learning model. Additional embodiments pertaining to such types of machine learning models are described herein with regard to machine learning model 210, object detection model 304, and block 604.

In some embodiments, the system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, ZigBee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the model (e.g., a version of the machine learning model that has yet to be trained) which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation, and a part of the input of the stack of layers. The processor subsystem 110 may be further configured to iteratively train the neural network using the training data 102 (e.g., thus generating updated versions of the machine learning model with respect to a first “untrained” version of the model). Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (“IO”) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

FIG. 2 illustrates a computer-implemented method for training and utilizing a neural network, according to some embodiments. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 214.

The computing system 202 may include a network interface device 220 that is configured to provide communication with external systems and devices. For example, the network interface device 220 may include a wired and/or wireless Ethernet interface as defined by Institute of Electrical and Electronics Engineers (IEEE) 802.11 family of standards. The network interface device 220 may include a cellular communication interface for communicating with a cellular network (e.g., 3G, 4G, 5G). The network interface device 220 may be further configured to provide a communication interface to an external network 222 or cloud.

The external network 222 may be referred to as the world-wide web or the Internet. The external network 222 may establish a standard communication protocol between computing devices. The external network 222 may allow information and data to be easily exchanged between computing devices and networks. One or more servers 224 may be in communication with the external network 222.

The computing system 202 may include an input/output (I/O) interface 218 that may be configured to provide digital and/or analog inputs and outputs. The I/O interface 218 may include additional serial interfaces for communicating with external devices (e.g., Universal Serial Bus (USB) interface).

The computing system 202 may include a human-machine interface (HMI) device 216 that may include any device that enables the system 200 to receive control input. Examples of input devices may include human interface inputs such as keyboards, mice, touchscreens, voice input devices, and other similar devices. The computing system 202 may include a display device 226. The computing system 202 may include hardware and software for outputting graphics and text information to the display device 226. The display device 226 may include an electronic display screen, projector, printer or other suitable device for displaying information to a user or operator. The computing system 202 may be further configured to allow interaction with remote HMI and remote display devices via the network interface device 220.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 214. The raw source dataset 214 may include raw or unprocessed sensor data that may be representative of an input dataset for a machine-learning system. The raw source dataset 214 may include video, video segments, images, text-based information, and raw or partially processed sensor data (e.g., radar map of objects). In some examples, the machine-learning algorithm 210 may be a neural network algorithm that is designed to perform a predetermined function. For example, the neural network algorithm may be configured in automotive applications to identify pedestrians in video images.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include source videos with and without pedestrians and corresponding presence and location information. The source videos may include various scenarios in which pedestrians are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., annotations) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), the machine-learning algorithm 210 may be executed using data that is not in the training dataset 212. The trained machine-learning algorithm 210 may be applied to new datasets to generate annotated data.

The machine-learning algorithm 210 may be configured to identify a particular feature in the raw source data 214. The raw source data 214 may include a plurality of instances or input dataset for which annotation results are desired. For example, the machine-learning algorithm 210 may be configured to identify the presence of a pedestrian in video images and annotate the occurrences. The machine-learning algorithm 210 may be programmed to process the raw source data 214 to identify the presence of the particular features. The machine-learning algorithm 210 may be configured to identify a feature in the raw source data 214 as a predetermined feature (e.g., pedestrian). The raw source data 214 may be derived from a variety of sources. For example, the raw source data 214 may be actual input data collected by a machine-learning system. The raw source data 214 may be machine generated for testing the system. As an example, the raw source data 214 may include raw video images from a camera.

In the example, the machine-learning algorithm 210 may process raw source data 214 and output an indication of a representation of an image. The output may also include augmented representation of the image. A machine-learning algorithm 210 may generate a confidence level or factor for each output generated. For example, a confidence value that exceeds a predetermined high-confidence threshold may indicate that the machine-learning algorithm 210 is confident that the identified feature corresponds to the particular feature. A confidence value that is less than a low-confidence threshold may indicate that the machine-learning algorithm 210 has some uncertainty that the particular feature is present.

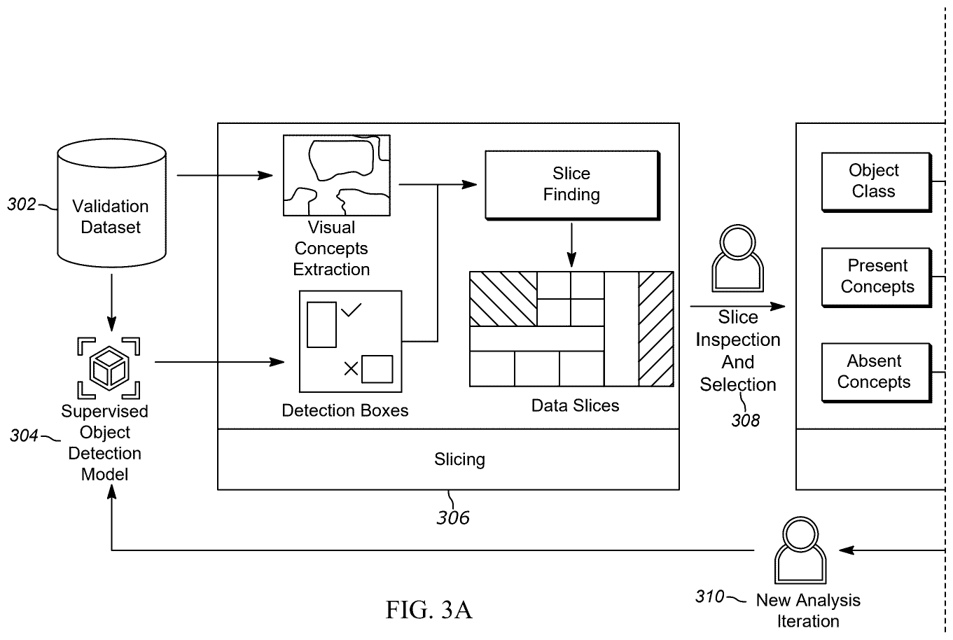

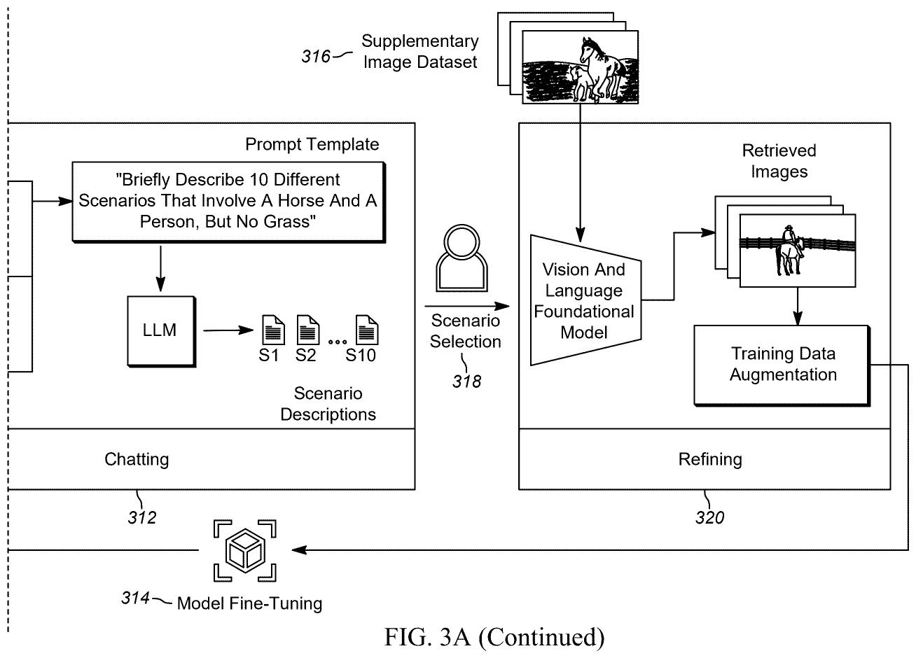

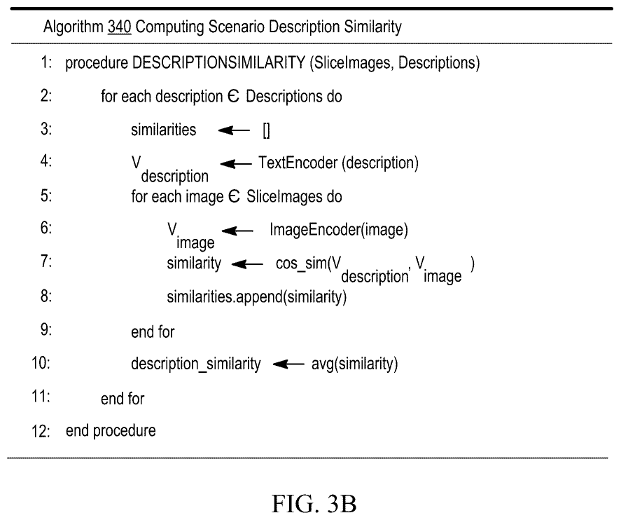

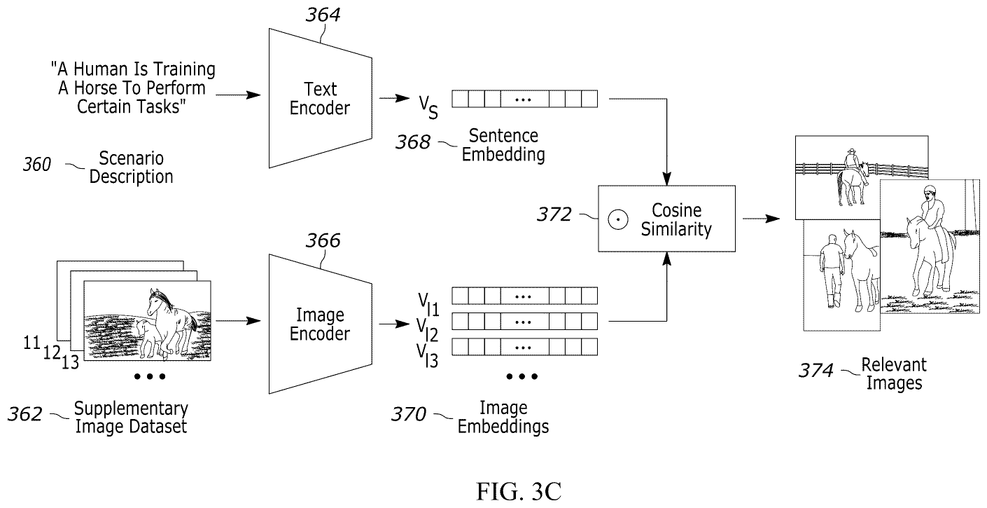

FIG. 3A is a workflow diagram that illustrates a process of executing an object detection model using a validation dataset and subsequently determining one or more methods for further fine-tuning the model, according to some embodiments.

In some embodiments, and in order to prepare a new training dataset for further fine-tune performance of an object detection model, slice finding techniques, such as those illustrated in FIG. 3A, are used to provide analytical results to a user of a machine learning model. The user may then guide the preparation of the subsequent training dataset based on edge cases that the machine learning network has identified. In some embodiments, and as illustrated throughout FIGS. 3A, 4, 5A, 5B, and 7 herein, the user may interact and provide instructions to the machine learning model at various moments in time throughout the process illustrated in FIG. 3A. Such interactions between a user and a machine learning network may also be referred to herein as a “human-in-the-loop” machine learning technique.

As shown in FIG. 3A, a process for further optimizing performance of an object detection model through data augmentation may include three stages that operate in an iterative manner. In Slicing block 306, a validation dataset 302 is executed using object detection model 304 in order to generate detected objects and identify data slices, as shown by Detection Boxes and Data Slices, respectively, within Slicing block 306. Then, the data slices are provided to the user for inspection and selection, as illustrated by arrow 308 in the figure. Once the user has identified one or more particular slices that are to be used to generate a subsequent training dataset, the machine learning network is configured to generate a natural language description associated with the image samples of those particular slice(s), followed by the generation of a series of related natural language descriptions, as shown in Chatting block 312. Then, the natural language descriptions are again provided to the user, as indicated by arrow 318, in order for the user to verify the relevance of the natural language descriptions in describing the image samples of the data slice(s). In Refining block 320, a vision and language foundational model may be executed in order to associate additional image samples with the set of natural language descriptions, which are then used to generate the subsequent training dataset. Finally, as also illustrated using model fine-tuning 314 and new analysis iteration 310 in the figure, the newly generated training dataset may be provided to the object detection model for further refinement of the model, and the overall process may begin again (e.g., if the model requires further optimizations). For example, object detection model 304 may execute the subsequent training dataset until convergence, at which point a trained version of the object detection model may then be output.

In additional detail, the first stage that is illustrated using Slicing block 306 involves finding under-performing data slices based on the model performance data and metadata that is generated using self-supervision techniques. As opposed to previously implemented data slice finding techniques which required high-quality and labor-intensive manual annotations to produce interpretable metadata, the present disclosure applies interpretable visual concepts that are identified using self-supervised learning approaches. In some embodiments, the visual concepts may be extracted as a form of a self-supervised semantic segmentation process. For each image sample within validation dataset 302, self-supervised semantic segmentation may be applied to extract one or more visual concepts or objects within the image sample. For example, if a given image sample illustrates a neighborhood or residential intersection, self-supervised semantic segmentation may be used to identify a stop sign, a person waiting at a crosswalk, and a tree that are within the frame that is captured in the image sample. Such a visual concepts extraction process collects all visual concepts that are present within the respective image samples of the validation datasets and applies a binary encoding to indicate their presence in each image, thus reflecting the overall image content.

As also illustrated in FIG. 3A, the same validation dataset is provided to the object detection model 304 for execution. As ground truth labels have been established using the extracted visual concepts described above, the execution of the object detection model using the validation dataset may also be referred to as a supervised learning technique. The object detection model then provides detected objects that have been identified within each image sample of the validation dataset. As illustrated within Slicing block 306, and continuing with the example image sample of the neighborhood or residential intersection introduced above, the object detection model may correctly identify the stop sign and the person waiting at a crosswalk, but not correctly identify the tree. Alternatively, the object detection model may misidentify the tree as another object, such as a fence post.

It should be understood that the extraction of the visual concepts and the execution of the object detection model may occur in parallel or sequentially, as the two sub processes are independent of one another as long as the validation dataset has already been generated. Once both the extraction of the visual concepts and the execution of the object detection model have been completed, the extracted visual concepts and the detected objects of the object detection model are input into a data slice finding algorithm.

In some embodiments, a slice finding algorithm may be performed on such metadata inputs in order to determine the effective groupings of underperforming image samples that share similar visual elements. Such a slice finding algorithm may have specific parameters that, together, provide a breadth-first slice finding toolkit, wherein the search time of the algorithm is proportional to search depth. The search depth then determines the maximum number of items that define a slice. An identified data slice that is defined by at most three visual concepts may conform to a breadth-first style slice finding technique that may be performed within a reasonable timeframe so as not to hinder the overall workflow shown in FIG. 3A.

In order to further expedite the data slice finding process, yet another parameter within the breadth-first slice finding toolkit may be to impose a limit to identifying slices that contain image samples of a single, same object class. Imposing such a parameter during the data slice finding process removes any unrelated image samples and/or visual concepts from identification into a particular slice during a pre-processing phase. For example, image samples that do not feature the given object class are discarded, and visual concepts that were not present within those image samples are purged.

Furthermore, as a breadth-first data slice finding process may lead to an increased number of identified slices that may also share high similarities with one another in comparison to a number of slices that might be identified if the breadth-first parameters within the toolkit were not applied, an additional pruning step may be incorporated as a post-processing step to the data slice finding algorithm shown in Slicing block 306. In some embodiments, the post-processing pruning step may involve computing a Jaccard similarity matrix for the slices that have been identified and removing one or more of the identified slices that have a similarity that is above an empirically determined threshold. The post-processing pruning step may additionally include further filtering one or more of the identified slices based on data slice size (e.g., how many of the total portion of image samples are included in a given data slice) and/or respective performance metric values (e.g., accuracy). Such pruning steps allow for more critical data slices that reflect more immediate and/or critical errors currently being made by the object detection model to be prioritized when considering how next to refine the object detection model.

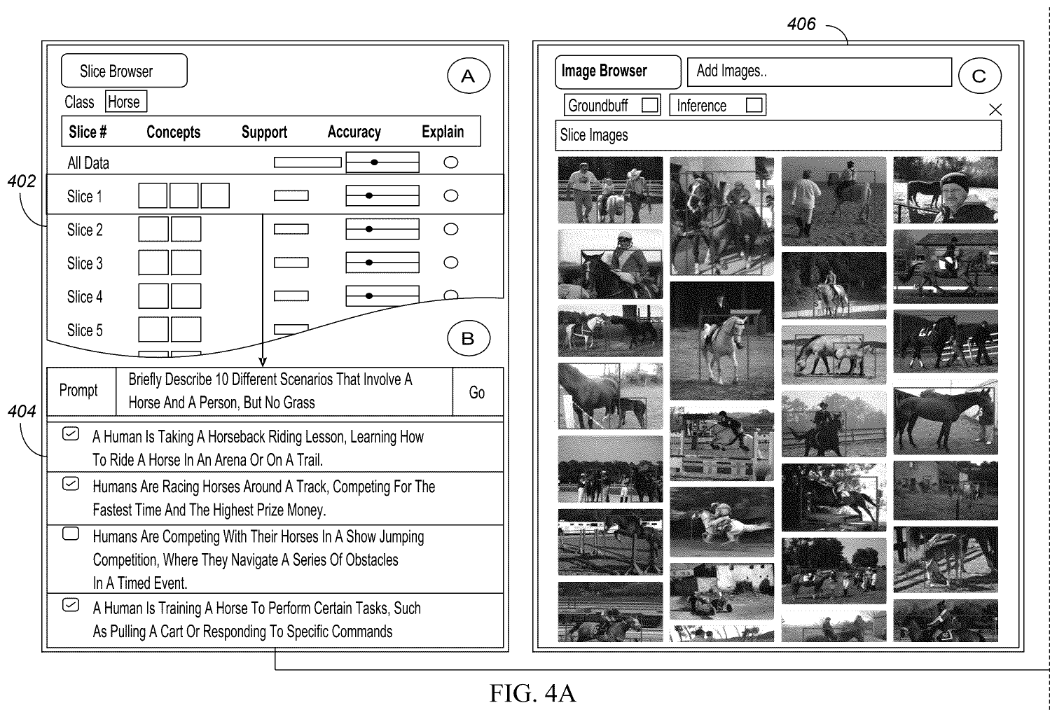

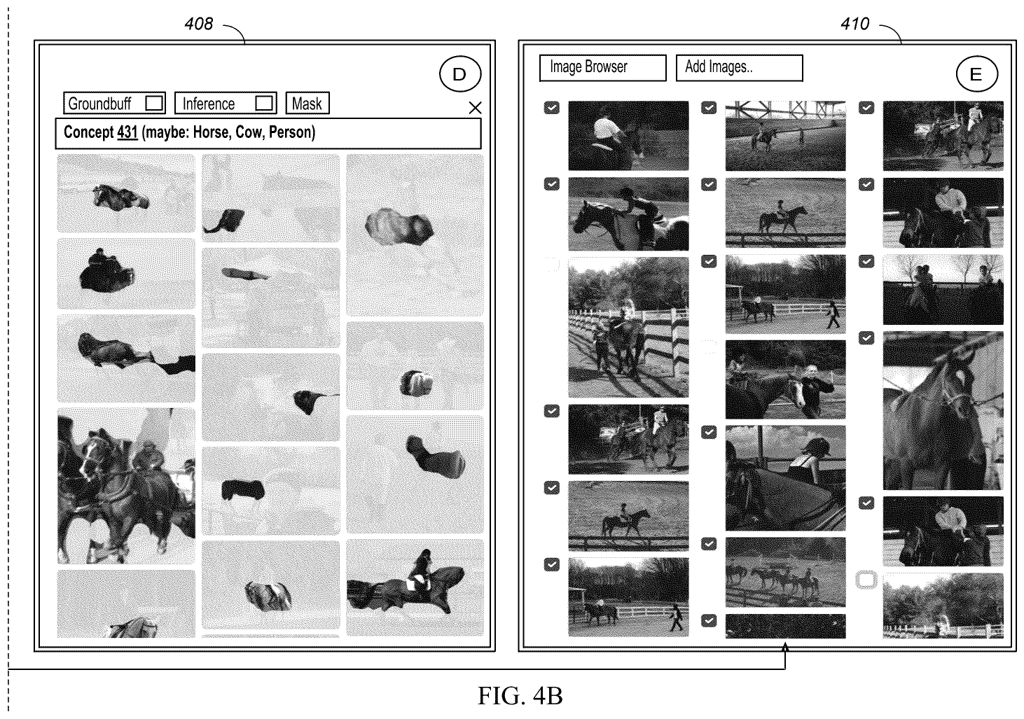

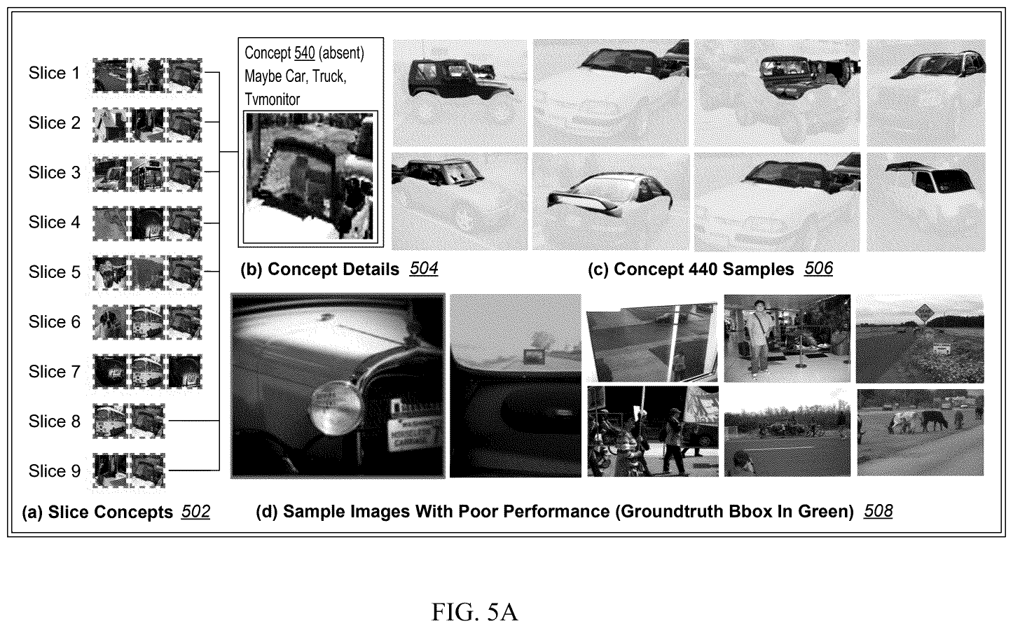

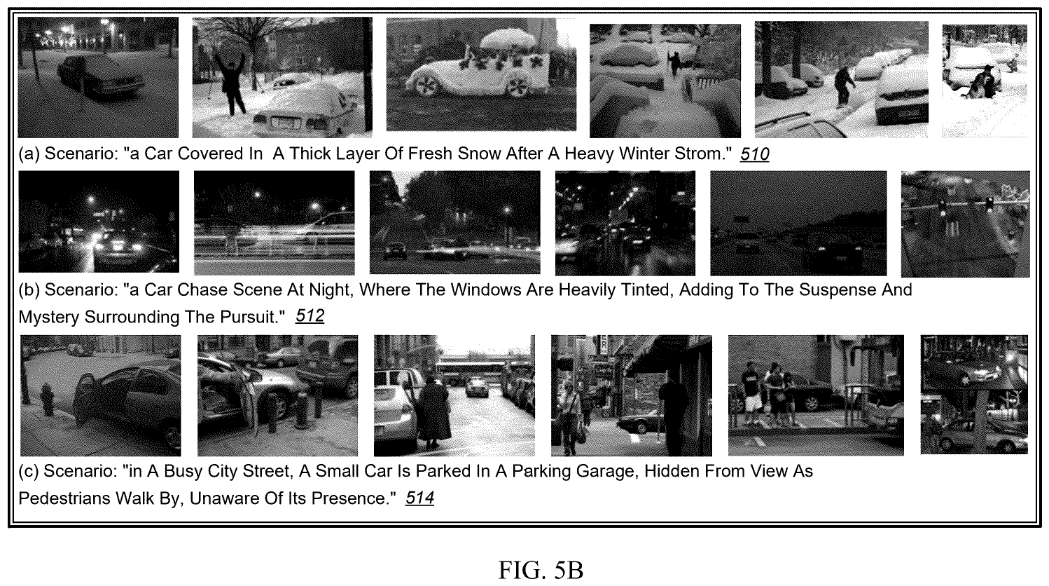

Once data slices have been identified the data slice finding algorithm within in Slicing block 306, the identified slices are provided to the user, as illustrated by slice inspection and selection 308. As additionally discussed herein with regard to FIGS. 4A-5B, the one or more processors of the system described herein may be configured to provide the identified slices to the user via a user interface. The user interface may allow the user to categorize the identified slices in various ways, such as by sorting the identified slices based on one or more performance metrics, based on slice size, etc. The user may then select a slice that they identify to be of general and/or critical to performance of the object detection model, and send a request to the machine learning network to prepare a subsequent training dataset that targets image samples, object class, visual concepts, or some combination of those aspects that correspond to the selected slice.

Once the system receives an indication of the slice that has been selected by the user, the machine learning network generates a natural language description that is associated with visual concepts of the selected slice. As illustrated in Chatting block 312, the natural language description may include some combination of a textual description of the object class, one or more present concepts, and one or more absent concepts that define the selected slice. In the example shown in FIG. 3A, the natural language description, “Briefly describe ten different scenarios that involve a horse and a person, but no grass” includes reference to “horse,” which is the given object class that all image samples within the selected slice fall under; “person,” which is a given visual concept that is present in all of the image samples within the selected slice; and “no grass,” which is a different visual concept that is absent in all of the image samples. In another example, and in continuation of the example introduced above wherein image samples within a given slice illustrate neighborhood or residential intersections, a natural language description that is generated by the machine learning network may resemble “Briefly describe a plurality of different scenarios that involve a residential intersection and a stop sign, but no dog.”

As shown in the above examples of natural language descriptions of the selected slice, the words “briefly describe” prepare the natural language description to be a prompt template that is then provided to a large language model (LLM), wherein the large language model is then executed in order to generate similar variations of natural language descriptions that may also be associated with specific visual concepts that are present and/or are absent in the image samples of the selected slice. By first generating a natural language description template that describes the key visual concepts and the object class of the selected slice, however, an overall theme of the image samples within the selected slice is reduced to text format.

In some embodiments, prior to providing the large language model with the generated prompt template, the natural language description is provided to the user for inspection. The user may then provide an indication to the machine learning network verifying the natural language description, or may provide an indication of one or more edits that are to be made to the description prior to submission to the large language model. For example, the user may provide an indication that “Briefly describe ten different scenarios that involve a horse and a person, but no grass” should be modified to “Briefly describe ten different scenarios that involve a horse and a person, but no saddle,” or some other variation that may better describe an overall theme of the image samples within the selected slice. Such an interaction with the user may resemble an iterative process, which may continue until the point at which the user confirms the exact language of the natural language description prompt template.

Chatting block 312 then involves the coordination, by the machine learning network, of providing the natural language description prompt template to the large language model to cause the LLM to generate associated variations of the original description. For example, the machine learning network may provide the LLM with “Briefly describe ten different scenarios that involve a horse and a person, but no grass,” and may receive the following variations in return: (i) “A human is taking a horseback riding less, learning how to ride a horse in an arena or on a trail.” (ii) “Humans are racing horses around a track, competing for the fastest time and the highest prize money.” (iii) “Humans are competing with their horses in a show jumping competition, where they navigate a series of obstacles in a timed event.” (iv) “A human is training a horse to perform certain tasks, such as pulling a cart or responding to specific commands.” (v) “Humans are working with horses in a therapeutic setting, using the horses' calming presence to help individuals with various mental health conditions.” (vi) “Humans are involved in the process of breeding horses, selecting specific horses to produce offspring with desirable traits.” (vii) “Humans are using horses to transport equipment and supplies on a camping or hunting trip.” (viii) “Humans are rescuing horses from neglectful or abusive situations and rehabilitating them for adoption or sanctuary.” (ix) “Humans are showing off their horses in a competition or exhibition, demonstrating their beauty, agility, and training.” (x) “Humans are taking a leisurely carriage ride, drawn by a horse, as a romantic or nostalgic activity.”

Once the machine learning network has received the associated variations of the original prompt template back from the large language model, the associated variations are provided to the user. In order to aid the user in making an informed analysis of the relevance and usefulness of the particular associated variations, the associated variations may be provided to the user, via the user interface, using interactive widgets or some other visual representation of the respective variations to the original prompt template. An example of such an implementation is shown in section 404 of the user interface of FIG. 4A.

In order to further aid the user in making an informed analysis of the relevance and usefulness of the associated variations, the associated variations may be input into an algorithm, such as Algorithm 340 shown in FIG. 3B. When provided to Algorithm 340, the associated variations are given similarity metric values based on the average cosine similarity between each pair. The natural language descriptions may then be hierarchically organized, sorted, or otherwise ranked based on similarity to one another, according to some embodiments.

Continuing with the ten example associated variations of “Briefly describe ten different scenarios that involve a horse and a person, but no grass,” given above, the corresponding ten associated variations may be given the following similarity metric values when input into Algorithm 340: (i) 0.2570; (ii) 0.2481; (iii) 0.2415; (iv) 0.2407; (v) 0.2385; (vi) 0.2336; (vii) 0.2307; (vii) 0.2292; (ix) 0.2037; (x) 0.2008. The similarity metric values may then be used to sort the various natural language descriptions for the user via the user interface. For example, section 404 of FIG. 4A provides the first four associated variations of “Briefly describe ten different scenarios that involve a horse and a person, but no grass,” that have been sorted in descending order, from most to least similar.

As illustrated using arrow 318 in FIG. 3A, the user has authority to remove one or more of the associated variations of the original prompt template if so inclined. For example, the user may determine that a given one of the associated variations strays too far from the overall theme of the image samples, or the user may determine that two of the given ones of the associated variations are too similar to one another to be both required in the next stage, e.g., Refining block 320. The machine learning network may be configured to remove those particular natural language descriptions if/when the processors receive such indications from the user.

In Refining block 320, a training dataset is augmented by querying similar data from a supplementary dataset. In order to efficiently prepare a supplemental training dataset, the associated variations of the original natural language description template are arranged according to semantic similarity to the original image samples within the selected slice. As further detailed with regard to FIG. 3C, such an arrangement is coordinated by obtaining unified embeddings for both the natural language descriptions and the image samples within the selected slice, using a vision and language foundational model.

FIG. 3C is another workflow diagram that further illustrates the process introduced in FIG. 3A, wherein encodings of natural language descriptions and of supplementary images are used to generate images that may be used within a supplementary training dataset, according to some embodiments.

As shown in FIG. 3C, scenario description 360 may refer to the plurality of natural language descriptions that were generated in Chatting block 312, and supplementary image dataset 362 may refer to any additional image samples that the machine learning network has access to. In some embodiments, a pre-processing step may occur wherein the machine learning network retrieves image samples from a reserve of image samples that the processors have access to, wherein the retrieved image samples are within the same theme as the original image samples in the validation dataset.

Then, scenario description 360 are processed through text encoder 364 to output sentence embedding 368, and supplementary image dataset 362 is processed through image encoder 366 to output image embeddings 370. As the image samples within supplementary image dataset 362 are converted into image embeddings 370, the sentence embedding 368 may be compared to image embeddings 370 in a query process using a cosine similarity function 372. Relevant images 374 are then provided to the user via the user interface.

In some embodiments, the user may then select or remove various ones of the retrieved images, shown in Refining block 320 in FIG. 3A, prior to the training data augmentation step. The user-verified image samples are then used to generate the supplemental training dataset, in addition to various ones of the image samples of the selected slice. By generating a supplemental training dataset that has merged originally problematic image samples with new image samples that are within a same object class and/or visual concepts theme, the object detection model may be refined in order to correct for the specific type of error identified by the selected slice definition.

After the third stage in the workflow shown in FIG. 3A is complete, model fine-tuning 314 marks the end of a given round of the workflow. The supplemental training dataset that has been generated according to Refining block 320 is then provided to object detection model 304 in new analysis iteration 310. The object detection model is fine-tuned on the supplementary training dataset for one epoch, and the process continues. Such an iterative process improves the model's overall performance by addresses its weaknesses.

FIGS. 4A and 4B illustrate an example application of the workflow diagram, introduced in FIG. 3A, into an edge case detection iteration for a given object detection model, according to some embodiments.

FIGS. 4A and 4B continue with the examples introduced above in FIGS. 3A and 3C, e.g., with image samples that have largely to do with the “horse” object class. The following description pertains to various “human-in-the-loop” moments in time that take place throughout the workflow shown in FIG. 3A, and are illustrated using an example user interface that is made available to the user during a given iteration of data slice finding and generating of a supplemental training dataset. The user interface shown focuses on slice browsing and failure diagnosing capabilities that are meant to aid the user with how to interact with the processors that are configured to perform edge case detection and generation of the supplemental training dataset.

Specifically, FIGS. 4A and 4B illustrate how methods and techniques described herein help alleviate object detection model defects that are caused by complicated cases involving spurious correlations and object overlapping. The particular implementation of this discussion of spurious correlations and object overlapping involves the “horse” object class.

Section 402 of the user interface demonstrates a moment in time after which point data slices have been identified in Slicing block 306 of FIG. 3A, and demonstrates a tabular configuration that ranks the poorest performing data slices. Each row in the tabular configuration may provide further information to the user, such as performance metric values and core details about a given slice, including the slice's index, representative visual concepts, support, and accuracy. For example, an accuracy performance metric may be defined herein by accuracy=min_{bbox}_{₁}_{, bbox}_{₂}_{, . . . , bbox}_{_{T}}(IoU) to represent the model's poorest performance in cases involving multiple target objects in the image.

As shown in the figure, section 402 shows that the object detection model that detects objects of the class “horse” currently has the worst performance on slice 1. If the user were to click on the row in section 402 for slice 1, section 406 and section 408 may be provided to the user by the machine learning network.

Section 406, labeled Image Browser in the figure, allows the user to visualize the ground truth labels (e.g., generated using self-supervised semantic segmentation methods described in Slicing block 306) vs inference of the object detection model. In some embodiments, the user interface may be configured to allow the user to toggle the visibility of ground truth labels and model inference bounding boxes, enhancing their understanding of prediction deviations.

Section 408, labeled Concept 431, allows the user to analyze the mistakes or errors that the model may currently be making (e.g., the model misidentifies certain visual concepts within the image samples as maybe pertaining to cows or people). If, when clicking through other concepts within slice 1, the user realizes that there is confusion on the part of the object detection model of whether or not there is a person present (e.g., by reading through “present concepts” and “absent concepts” and finding “human” in both), then the user may begin to understand the spurious correlation. By analyzing the images provided via the user interface, the user may also determine that a large number of image samples within slice 1 depict people riding horses on the ground without grass. Thus, they may infer that there may be a spurious correlation between “horse” and “grass.” They may also further deduce that image samples that include both horses and human torsos cause misinterpretations by the model, which then leads to a wrong prediction or low confidence in related scenarios.

By further analyzing sections 406 and 408, the user may determine that this poor performance related to the “horse” object class may be related to a spurious correlation between horses and grass, as well as being related to an overlap in the image samples between horses and human torsos. In order to offer an efficient, high-level understanding to the user of the given slice and provide directed suggestions about possible reasons for the model's current failures, each slice may be summarized using a selection of representative concepts, in addition to supporting sample images browsing. As shown in section 402 of FIG. 4A, each visual concept within a given slice is depicted as a representative thumbnail, with solid line borders indicating presence and dotted line borders indicating absence of certain visual concepts. For more in-depth insight, the user interface may be configured to display a tooltip upon hovering over a given visual concept, which then provides the concept index, reference keywords, and an enlarged thumbnail to the user. As accurate concept perception is crucial to understanding model failures, each concept of each slice may be presented to the user using sections 402-408 of the user interface, for maximal and diverse visibility of the model's current weaknesses and strengths.

In the particular embodiments shown in the figure, a button may also be clicked by the user to trigger a natural language description of the given slice. As illustrated in section 404, when the user selects slice 1 to be used to generate the supplemental training dataset, the corresponding natural language description may be generated by the machine learning network. As introduced above, the natural language description prompt template that is generated by the machine learning network is “Briefly describe ten different scenarios that involve a horse and a person, but no grass,” and is meant to correspond to the object class and various visual concepts that may be present and/or absent in the image samples of slice 1. It may be understood that slice 1 has been selected in the particular embodiment shown in FIG. 4A. However similar natural language descriptions may also be generated if the user were to select slice 2, slice 3, etc. As introduced above, the user may iterate on the natural language description prompt template shown in section 404 by providing edits to the machine learning network.

The rest of section 404 of FIG. 4A may then correspond to a moment in time after associated variations of the natural language template have been received from the large language model, as additionally illustrated in Chatting block 312 in FIG. 3A. The user may select or remove various ones of the associated variations of the original natural language description template, as also illustrated in section 404 of FIG. 4A (e.g., three descriptions are selected, and one description has been unselected).

Section 410 of FIG. 4B resembles a moment in time after which point the machine learning network has received the relevant image samples 374 back from the vision and language foundational model. The user may then select or remove various ones of the image samples, before they are then used in combination with some of the image samples from the original validation dataset to generate the supplemental training dataset that targets problems identified in slice 1. By augmenting the available image samples dataset with the newly imported images, the fine-tuning and retraining processes of the object detection model is simplified.

As additionally introduced in FIG. 3A above, the user interface may be used iteratively, following each new round of retraining of the object detection model using the newly generated training dataset from the previous round.

FIGS. 5A and 5B illustrate another example application of the workflow diagram, introduced in FIG. 3A, into an edge case detection iteration for another object detection model, according to some embodiments.

In the scenario illustrated in FIGS. 5A and 5B, a given object detection model is currently being validated for detecting cars based on visual concepts related to cars. As with the previous example in FIGS. 4A and 4B, section 502 illustrated identified slices following execution of a data slice finding algorithm. Upon searching through various concepts within the user interface, the user in this case deduces that there appears to be significant issue with the absent visual concept shown in section 504. As then further illustrated in sections 506 and 508 of the user interface, the user inferred that there was a correlation between the particular absent visual concept and windows and windshields of cars. In multiple slices wherein concept 540 is labeled as an absent visual concept, windows of cars were either not visible due to the viewing angle or the cars were small enough that there was subsequent misidentifications by the model.

By following the workflow illustrated in FIG. 3A, the machine learning network then generated a natural language description template to “describe scenarios that involve cars but car windows are not visible.” Among the associated variations may then be natural language descriptions such as (i) “A car covered in a thick layer of fresh snow after a heavy winter storm.” (ii) “A car chase scene at night, where the windows are heavily tinted, adding to the suspense and mystery surrounding the pursuit.” (iii) “In a busy city street, a small car is parked in an underground parking garage, hidden from view as pedestrians walk by, unaware of its presence.” FIG. 5B then illustrates example relevant images 510, 512, and 514, that have been executed by the vision and language foundational model. The machine learning network is then configured to generate a supplemental training dataset based on those images.

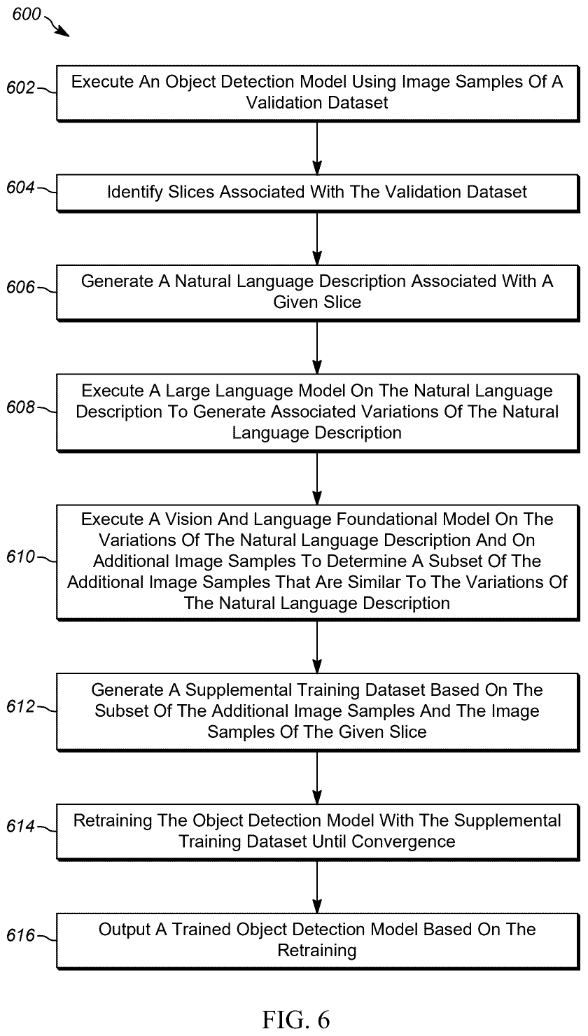

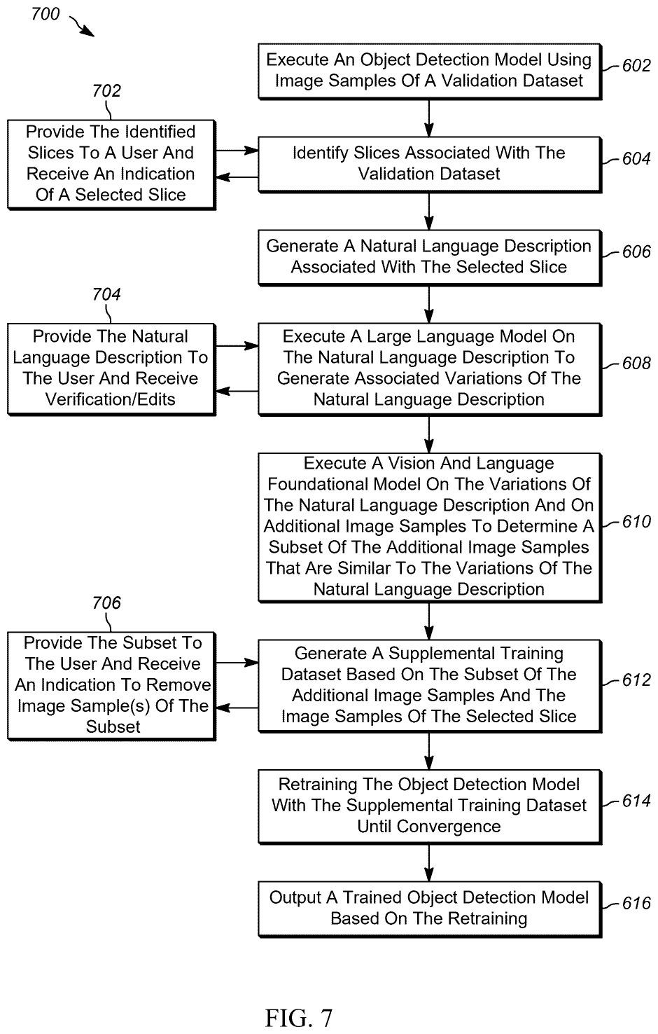

FIG. 6 is a flow diagram that illustrates a process of identifying slices, subsequent to executing a validation dataset through an object detection model, and then using that analytical information to prepare an additional training dataset to further train the object detection model, according to some embodiments. In addition, FIG. 7 further illustrates that process, wherein FIG. 7 demonstrates moments of interaction between a user of a machine learning network and the processors that are executing the object detection model, according to some embodiments.

In the following description of flow charts 600 and 700, flow chart 600 illustrates methods used to conduct various functions of the present disclosure from a perspective of one or more processors that are configured to execute an object detection model, coordinate with a large language model and a vision and language foundational model, and interact with a user of the machine learning network. Flow chart 700 then illustrates various moments during the process shown in FIG. 6 wherein the processors provide information to the user and receive instructions back from the user about how to proceed. Such interactions between a user and a machine learning network may also be described as a “human-in-the-loop” machine learning technique.

In block 602, image samples of a validation dataset, such as validation dataset 302, are provided to an object detection model for execution. Then, a data slice finding algorithm is applied, in block 604, in order to identify slices that are of general and/or critical concern due to poor performance when run through the object detection model. As shown in block 702, the identified slices may then be provided to a user of the machine learning network, in order for them to select a given slice that is to be used to generate a supplemental training dataset.

In block 606, the machine learning network then generates a natural language description that is associated with the selected slice. The generated description acts as a prompt template that is firstly verified and/or edited by the user in block 704, and then is secondly provided to a large language model, in block 608, for execution in order to generate associated variations of the original natural language description. In block 610, a vision and language foundational model is then executed using the variations of the natural language description and additional image samples that are made accessible and/or otherwise sourced to/by the machine learning network in order to determine a subset of the additional image samples that are similar (e.g., via a cosine similarity or some other quantifiable relevancy metric) to the variations of the natural language description. Following a determination of the subset of additional images, the process of preparing and generating a supplemental training dataset begins.

In some embodiments, the subset of the additional image samples may be provided to the user, in block 706, at which point the user may verify the subset and/or provide an indication to remove certain ones of the subset. The machine learning network is then configured to augment original image samples of the validation dataset with the subset of additional image samples to generate the supplemental training dataset, and provide, in block 614, the supplemental training dataset to the object detection model for execution. The object detection model may be trained on the supplemental training dataset until convergence, at which point a trained version of the object detection model is output, as shown in block 616.

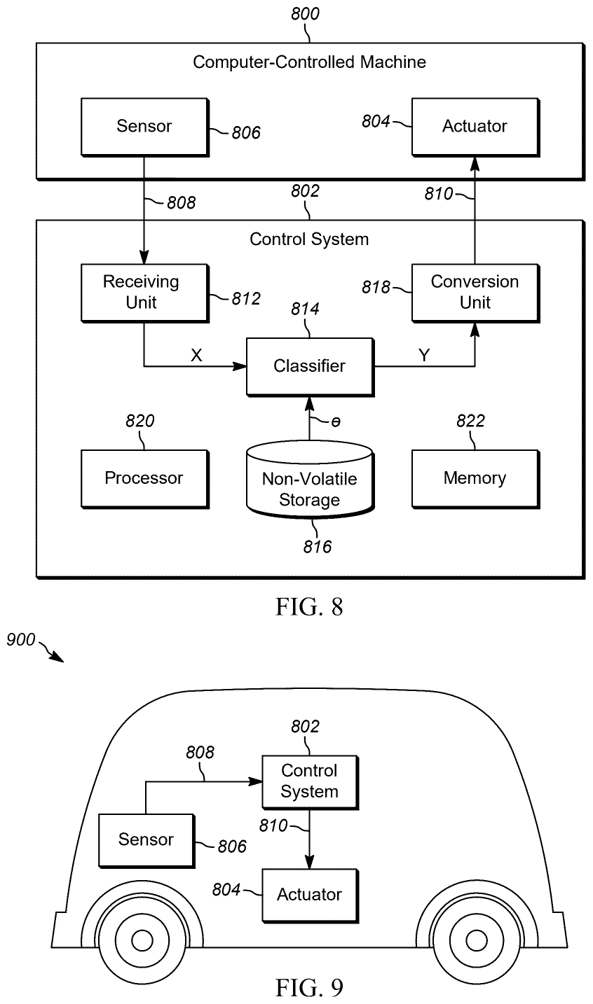

The methods and systems disclosed herein can be used in many different applications. Determining out-of-distribution data, edge cases, false positive errors, false negative errors, or other performance metric and domain-specific metrics can be useful for a plethora of technologies, examples of which are illustrated in FIGS. 8-14. FIG. 8 depicts a schematic diagram of an interaction between a computer-controlled machine 800 and a control system 802. Computer-controlled machine 800 includes actuator 804 and sensor 806. Actuator 804 may include one or more actuators and sensor 806 may include one or more sensors. Sensor 806 is configured to sense a condition of computer-controlled machine 800. Sensor 806 may be configured to sense ID and/or OOD data, and the corresponding processors can be configured to determine whether the data is ID or OOD according to the teachings herein. Sensor 806 may be configured to encode the sensed condition into sensor signals 808 and to transmit sensor signals 808 to control system 802. Non-limiting examples of sensor 806 include a camera, video sensor, radar, LiDAR, ultrasonic and motion sensors, temperature sensors, and the like. In one embodiment, sensor 806 is an optical sensor configured to sense optical images of an environment proximate to computer-controlled machine 800.

Control system 802 is configured to receive sensor signals 808 from computer-controlled machine 800. As set forth below, control system 802 may be further configured to compute actuator control commands 810 depending on the sensor signals and to transmit actuator control commands 810 to actuator 804 of computer-controlled machine 800.

As shown in FIG. 9, control system 802 includes receiving unit 812. Receiving unit 812 may be configured to receive sensor signals 808 from sensor 806 and to transform sensor signals 808 into input signals x. In an alternative embodiment, sensor signals 808 are received directly as input signals x without receiving unit 812. Each input signal x may be a portion of each sensor signal 808. Receiving unit 812 may be configured to process each sensor signal 808 to product each input signal x. Input signal x may include data corresponding to an image recorded by sensor 806.

Control system 802 includes a classifier 814. Classifier 814 may be configured to classify input signals x into one or more labels using a machine-learning algorithm, such as a neural network described above. Classifier 814 is configured to be parametrized by parameters, such as those described above (e.g., parameter θ). Parameters θ may be stored in and provided by non-volatile storage 816. Classifier 814 is configured to determine output signals y from input signals x. Each output signal y includes information that assigns one or more labels to each input signal x. Classifier 814 may transmit output signals y to conversion unit 818. Conversion unit 818 is configured to covert output signals y into actuator control commands 810. Control system 802 is configured to transmit actuator control commands 810 to actuator 804, which is configured to actuate computer-controlled machine 800 in response to actuator control commands 810. In another embodiment, actuator 804 is configured to actuate computer-controlled machine 800 based directly on output signals y.

Upon receipt of actuator control commands 810 by actuator 804, actuator 804 is configured to execute an action corresponding to the related actuator control command 810. Actuator 804 may include a control logic configured to transform actuator control commands 810 into a second actuator control command, which is utilized to control actuator 804. In one or more embodiments, actuator control commands 810 may be utilized to control a display instead of or in addition to an actuator.

In another embodiment, control system 802 includes sensor 806 instead of or in addition to computer-controlled machine 800 including sensor 806. Control system 802 may also include actuator 804 instead of or in addition to computer-controlled machine 800 including actuator 804.

As shown in FIG. 9, control system 802 also includes processor 820 and memory 822. Processor 820 may include one or more processors. Memory 822 may include one or more memory devices. The classifier 814 of one or more embodiments may be implemented by control system 802, which includes non-volatile storage 816, processor 820 and memory 822.

Non-volatile storage 816 may include one or more persistent data storage devices such as a hard drive, optical drive, tape drive, non-volatile solid-state device, cloud storage or any other device capable of persistently storing information. Processor 820 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 822. Memory 822 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. Moreover, processor 820 and memory 822 may be configured to provide collected data to one or more other computing devices that are configured to train and/or validate the machine learning model within domain-specific embodiments shown throughout FIGS. 8-14. Such collected data may be used to generate training datasets and validation datasets for various stages in preparing and executing a machine learning model into industry-grade applications. Within a context described herein with regard to edge case detection, processor 820 and memory 822 may be coupled to or otherwise remotely connected to computing devices that may then conduct validation processes such as those described above.

Processor 820 may be configured to read into memory 822 and execute computer-executable instructions residing in non-volatile storage 816 and embodying one or more machine-learning algorithms and/or methodologies of one or more embodiments. Non-volatile storage 816 may include one or more operating systems and applications. Non-volatile storage 816 may store compiled and/or interpreted from computer programs created using a variety of programming languages and/or technologies, including, without limitation, and cither alone or in combination, Java, C, C++, C#, Objective C, Fortran, Pascal, Java Script, Python, Perl, and PL/SQL.

Upon execution by processor 820, the computer-executable instructions of non-volatile storage 816 may cause control system 802 to implement one or more of the machine-learning algorithms and/or methodologies as disclosed herein. Non-volatile storage 816 may also include machine-learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 9 depicts a schematic diagram of control system 802 configured to control vehicle 900, which may be an at least partially autonomous vehicle or an at least partially autonomous robot. Vehicle 900 includes actuator 804 and sensor 806. Sensor 806 may include one or more video sensors, cameras, radar sensors, ultrasonic sensors, LiDAR sensors, and/or position sensors (e.g. GPS). One or more of the one or more specific sensors may be integrated into vehicle 900. In the context of sign-recognition and processing as described herein, the sensor 806 is a camera mounted to or integrated into the vehicle 900. Alternatively or in addition to one or more specific sensors identified above, sensor 806 may include a software module configured to, upon execution, determine a state of actuator 804. One non-limiting example of a software module includes a weather information software module configured to determine a present or future state of the weather proximate vehicle 900 or other location.

Classifier 814 of control system 802 of vehicle 900 may be configured to detect objects in the vicinity of vehicle 900 dependent on input signals x. In such an embodiment, output signal y may include information characterizing the vicinity of objects to vehicle 900. Actuator control command 810 may be determined in accordance with this information. The actuator control command 810 may be used to avoid collisions with the detected objects.

In embodiments where vehicle 900 is an at least partially autonomous vehicle, actuator 804 may be embodied in a brake, a propulsion system, an engine, a drivetrain, or a steering of vehicle 900. Actuator control commands 810 may be determined such that actuator 804 is controlled such that vehicle 900 avoids collisions with detected objects. Detected objects may also be classified according to what classifier 814 deems them most likely to be, such as pedestrians or trees. The actuator control commands 810 may be determined depending on the classification. In a scenario where an adversarial attack may occur, the system described above may be further trained to better detect objects or identify a change in lighting conditions or an angle for a sensor or camera on vehicle 900.

In other embodiments where vehicle 900 is an at least partially autonomous robot, vehicle 900 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 810 may be determined such that a propulsion unit, steering unit and/or brake unit of the mobile robot may be controlled such that the mobile robot may avoid collisions with identified objects.

In another embodiment, vehicle 900 is an at least partially autonomous robot in the form of a gardening robot. In such embodiment, vehicle 900 may use an optical sensor as sensor 806 to determine a state of plants in an environment proximate vehicle 900. Actuator 804 may be a nozzle configured to spray chemicals. Depending on an identified species and/or an identified state of the plants, actuator control command 810 may be determined to cause actuator 804 to spray the plants with a suitable quantity of suitable chemicals.

Vehicle 900 may be an at least partially autonomous robot in the form of a domestic appliance. Non-limiting examples of domestic appliances include a washing machine, a stove, an oven, a microwave, or a dishwasher. In such a vehicle 900, sensor 806 may be an optical sensor configured to detect a state of an object which is to undergo processing by the household appliance. For example, in the case of the domestic appliance being a washing machine, sensor 806 may detect a state of the laundry inside the washing machine. Actuator control command 810 may be determined based on the detected state of the laundry.

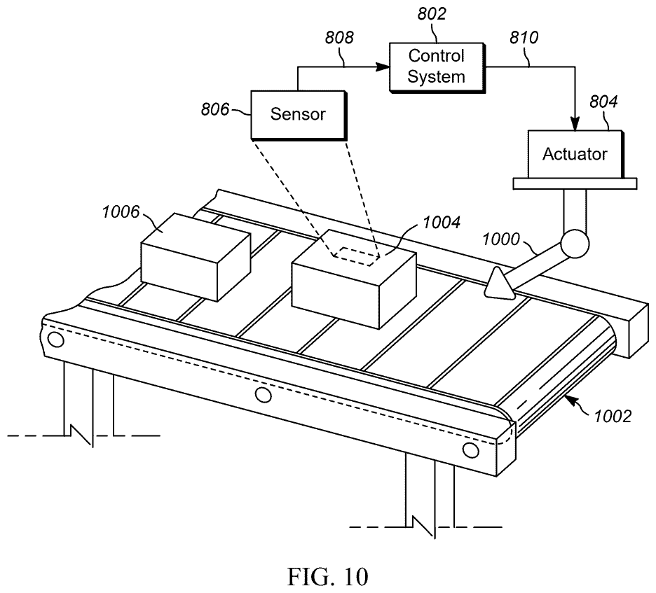

FIG. 10 depicts a schematic diagram of control system 802 configured to control system 1000 (e.g., manufacturing machine), such as a punch cutter, a cutter or a gun drill, of manufacturing system 1002, such as part of a production line. Control system 802 may be configured to control actuator 804, which is configured to control system 1000 (e.g., manufacturing machine).

Sensor 806 of system 1000 (e.g., manufacturing machine) may be an optical sensor configured to capture one or more properties of manufactured product 1004. Classifier 814 may be configured to determine a state of manufactured product 1004 from one or more of the captured properties. Actuator 804 may be configured to control system 1000 (e.g., manufacturing machine) depending on the determined state of manufactured product 1004 for a subsequent manufacturing step of manufactured product 1004. The actuator 804 may be configured to control functions of system 1000 (e.g., manufacturing machine) on subsequent manufactured product 1006 of system 1000 (e.g., manufacturing machine) depending on the determined state of manufactured product 1004.

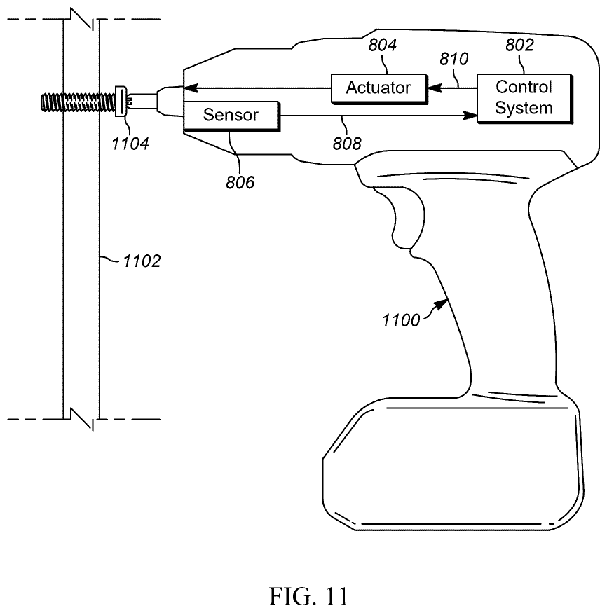

FIG. 11 depicts a schematic diagram of control system 802 configured to control power tool 1100, such as a power drill or driver, that has an at least partially autonomous mode. Control system 802 may be configured to control actuator 804, which is configured to control power tool 1100.

Sensor 806 of power tool 1100 may be an optical sensor configured to capture one or more properties of work surface 1102 and/or fastener 1104 being driven into work surface 1102. Classifier 814 within control system 802 may be configured to determine a state of work surface 1102 and/or fastener 1104 relative to work surface 1102 from one or more of the captured properties. The state may be fastener 1104 being flush with work surface 1102. The state may alternatively be hardness of work surface 1102. Actuator 1104 may be configured to control power tool 1100 such that the driving function of power tool 1100 is adjusted depending on the determined state of fastener 1104 relative to work surface 1102 or one or more captured properties of work surface 1102. For example, actuator 1104 may discontinue the driving function if the state of fastener 1104 is flush relative to work surface 1102. As another non-limiting example, actuator 1104 may apply additional or less torque depending on the hardness of work surface 1102.

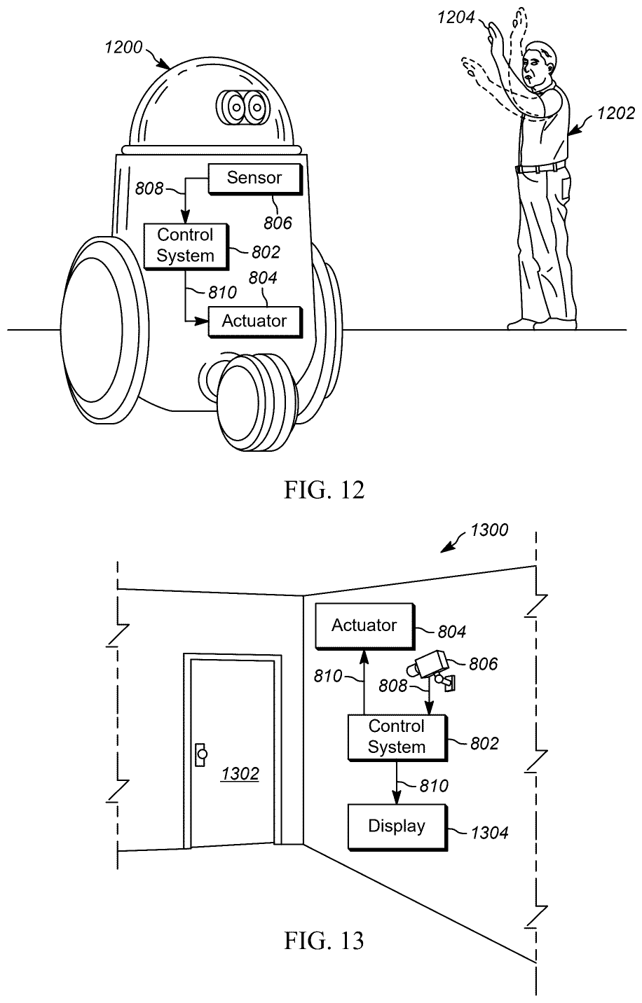

FIG. 12 depicts a schematic diagram of control system 802 configured to control automated personal assistant 1200. Control system 802 may be configured to control actuator 804, which is configured to control automated personal assistant 1200. Automated personal assistant 1200 may be configured to control a domestic appliance, such as a washing machine, a stove, an oven, a microwave or a dishwasher.

Sensor 806 may be an optical sensor and/or an audio sensor. The optical sensor may be configured to receive video images of gestures 1304 of user 1202. The audio sensor may be configured to receive a voice command of user 1202.

Control system 802 of automated personal assistant 1200 may be configured to determine actuator control commands 810 configured to control system 802. Control system 802 may be configured to determine actuator control commands 810 in accordance with sensor signals 808 of sensor 806. Automated personal assistant 1200 is configured to transmit sensor signals 808 to control system 802. Classifier 814 of control system 802 may be configured to execute a gesture recognition algorithm to identify gesture 1304 made by user 1202, to determine actuator control commands 810, and to transmit the actuator control commands 810 to actuator 804. Classifier 814 may be configured to retrieve information from non-volatile storage in response to gesture 1304 and to output the retrieved information in a form suitable for reception by user 1202.

FIG. 13 depicts a schematic diagram of control system 802 configured to control monitoring system 1300. Monitoring system 1300 may be configured to physically control access through door 1302. Sensor 806 may be configured to detect a scene that is relevant in deciding whether access is granted. Sensor 806 may be an optical sensor configured to generate and transmit image and/or video data. Such data may be used by control system 802 to detect a person's face.

Classifier 814 of control system 802 of monitoring system 1300 may be configured to interpret the image and/or video data by matching identities of known people stored in non-volatile storage 816, thereby determining an identity of a person. Classifier 814 may be configured to generate and an actuator control command 810 in response to the interpretation of the image and/or video data. Control system 802 is configured to transmit the actuator control command 810 to actuator 804. In this embodiment, actuator 804 may be configured to lock or unlock door 1302 in response to the actuator control command 810. In other embodiments, a non-physical, logical access control is also possible.

Monitoring system 1300 may also be a surveillance system. In such an embodiment, sensor 806 may be an optical sensor configured to detect a scene that is under surveillance and control system 802 is configured to control display 1304. Classifier 814 is configured to determine a classification of a scene, e.g. whether the scene detected by sensor 806 is suspicious. Control system 802 is configured to transmit an actuator control command 810 to display 1304 in response to the classification. Display 1304 may be configured to adjust the displayed content in response to the actuator control command 810. For instance, display 1304 may highlight an object that is deemed suspicious by classifier 814. Utilizing an embodiment of the system disclosed, the surveillance system may predict objects at certain times in the future showing up.

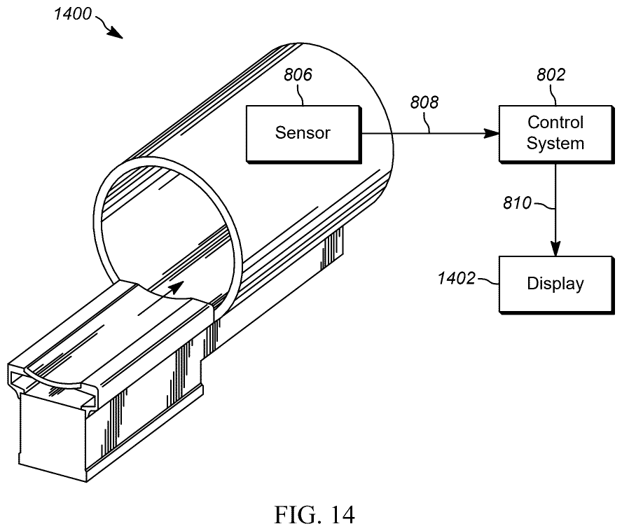

FIG. 14 depicts a schematic diagram of control system 802 configured to control imaging system 1400, for example an MRI apparatus, x-ray imaging apparatus or ultrasonic apparatus. Sensor 806 may, for example, be an imaging sensor. Classifier 814 may be configured to determine a classification of all or part of the sensed image. Classifier 814 may be configured to determine or select an actuator control command 810 in response to the classification obtained by the trained neural network. For example, classifier 814 may interpret a region of a sensed image to be potentially anomalous. In this case, actuator control command 810 may be determined or selected to cause display 1402 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for a machine learning network, comprising:
executing an object detection model to detect one or more objects within respective image samples of a validation dataset;
identifying slices associated with two or more of the image samples;
generating a natural language description associated with a given slice of the identified slices;
executing a large language model on the natural language description to generate associated variations of the natural language description; and
executing a vision and language foundational model on the variations of the natural language description and on additional image samples that are accessible by the machine learning network to determine a subset of the additional image samples that are similar to the variations of the natural language description;
generating a supplemental training dataset based on the subset of the additional image samples and the image samples of the given slice;
retraining the object detection model with the supplemental training dataset until convergence; and
outputting a trained object detection model based on the retraining.

2. The computer-implemented method of claim 1, wherein the identification of the slices comprises:
extracting visual concepts from the image samples of the validation dataset;
comparing the extracted visual concepts to the one or more objects, detected by the object detection model; and
defining, for a given slice, respective patterns of the extracted visual concepts that the object detection model did not correctly detect within two or more of the image samples.

3. The computer-implemented method of claim 2, wherein the defining, for the given slice, the respective patterns comprises verifying that the two or more of the image samples are within the same object class.

4. The computer-implemented method of claim 3, wherein:
the natural language description associated with the given slice comprises:
the same object class;
indications of one or more extracted visual concepts that are present in the image samples of the given slice; and
other indications of one or more other extracted visual concepts that are absent in the image samples of the given slice; and
a total number of the indications and the other indications is equal to or less than three.

5. The computer-implemented method of claim 1, wherein, subsequent to the identification of the slices, the method further comprises:
computing a Jaccard similarity matrix for the identified slices; and
removing one or more of the identified slices that have a similarity that is above an empirically determined threshold.

6. The computer-implemented method of claim 1, wherein, subsequent to the identification of the slices, the method further comprises:
displaying, via a user interface, the identified slices to a user of the machine learning network, wherein the identified slices are organized with respect to one or more of a performance metric and a number of the image samples within each slice; and
receiving, via the user interface, an indication from the user, selecting the given slice for the generation of the natural language description.

7. The computer-implemented method of claim 1, wherein, subsequent to the generation of the natural language description associated with the given slice, the method further comprises:
displaying, via a user interface, the natural language description to a user of the machine learning network;
receiving, via the user interface, an indication from the user to perform one or more edits to the natural language description; and
performing the one or more edits to the natural language description prior to the execution of the large language model.

8. The computer-implemented method of claim 1, wherein, subsequent to the execution of the vision and language foundational model, the method further comprises:
displaying, via a user interface, the subset of the additional image samples to a user of the machine learning network;
receiving, via the user interface, an indication from the user to remove one or more of the additional image samples of the subset; and
removing the one or more of the additional image samples from the subset, prior to the generation of the supplemental training dataset.

9. The computer-implemented method of claim 1, wherein, subsequent to the generation of the associated variations of the natural language description, the method further comprises:
determining a hierarchy of the associated variations based on an average cosine similarity between respective ones of the associated variations; and
displaying, via a user interface, the subset of the additional image samples to the user of the machine learning network based on the determined hierarchy.

10. The computer-implemented method of claim 1, wherein the generating the supplemental training dataset comprises augmenting the subset of the additional image samples to one or more image samples of the validation dataset that correspond to the given slice.

11. A system, comprising:
one or more processors; and
memory having program instructions that, when executed by the one or more processors, cause the one or more processors to:
execute an object detection model to detect one or more objects within respective image samples of a validation dataset;
identify slices associated with two or more of the image samples;
generate a natural language description associated with a given slice of the identified slices;
execute a large language model on the natural language description to generate associated variations of the natural language description; and
execute a vision and language foundational model on the variations of the natural language description and on additional image samples that are made accessible to determine a subset of the additional image samples that are similar to the variations of the natural language description;
generate a supplemental training dataset based on the subset of the additional image samples and the image samples of the given slice;
retrain the object detection model with the supplemental training dataset until convergence; and
output a trained object detection model based on the retraining.

12. The system of claim 11, wherein, to identify the slices, the program instructions further cause the one or more processors to:
extract visual concepts from the image samples of the validation dataset;
compare the extracted visual concepts to the one or more objects, detected by the object detection model; and
define, for a given slice, respective patterns of the extracted visual concepts that the object detection model did not correctly detect within two or more of the image samples.

13. The system of claim 12, wherein, to define, for the given slice, the respective patterns, the program instructions further cause the one or more processors to verify that the two or more of the image samples are within the same object class.

14. The system of claim 13, wherein:
the natural language description associated with the given slice comprises:
the same object class;
indications of one or more extracted visual concepts that are present in the image samples of the given slice; and
other indications of one or more other extracted visual concepts that are absent in the image samples of the given slice; and
a total number of the indications and the other indications is equal to or less than three.

15. The system of claim 11, wherein, subsequent to the identification of the slices, the program instructions further cause the one or more processors to:
compute a Jaccard similarity matrix for the identified slices; and
remove one or more of the identified slices that have a similarity that is above an empirically determined threshold.

16. The system of claim 11, wherein, subsequent to the identification of the slices, the program instructions further cause the one or more processors to:
display, via a user interface, the identified slices to a user, wherein the identified slices are organized with respect to one or more of a performance metric and a number of the image samples within each slice; and
receive, via the user interface, an indication from the user, selecting the given slice for the generation of the natural language description.

17. One or more non-transitory, computer-readable media storing program instructions that, when executed on or across one or more processors, cause the one or more processors to:
execute an object detection model to detect one or more objects within respective image samples of a validation dataset;
identify slices associated with two or more of the image samples;
generate a natural language description associated with a given slice of the identified slices;
execute a large language model on the natural language description to generate associated variations of the natural language description; and
execute a vision and language foundational model on the variations of the natural language description and on additional image samples that are made accessible to determine a subset of the additional image samples that are similar to the variations of the natural language description;
generate a supplemental training dataset based on the subset of the additional image samples and the image samples of the given slice;
retrain the object detection model with the supplemental training dataset until convergence; and
output a trained object detection model based on the retraining.

18. The one or more non-transitory, computer-readable media of claim 17, wherein, to identify the slices, the program instructions further cause the one or more processors to:
extract visual concepts from the image samples of the validation dataset;
compare the extracted visual concepts to the one or more objects, detected by the object detection model; and
define, for a given slice, respective patterns of the extracted visual concepts that the object detection model did not correctly detect within two or more of the image samples.

19. The one or more non-transitory, computer-readable media of claim 17, wherein, subsequent to the identification of the slices, the program instructions further cause the one or more processors to:
compute a Jaccard similarity matrix for the identified slices; and
remove one or more of the identified slices that have a similarity that is above an empirically determined threshold.

20. The one or more non-transitory, computer-readable media of claim 17, wherein, subsequent to the identification of the slices, the program instructions further cause the one or more processors to:
display, via a user interface, the identified slices to a user, wherein the identified slices are organized with respect to one or more of a performance metric and a number of the image samples within each slice; and
receive, via the user interface, an indication from the user, selecting the given slice for the generation of the natural language description.
